(19) United States
(12) Patent Application Publication
(10) Pub. No.: US 2013/0145884 A1
(43) Pub. Date: Jun. 13, 2013

(54) Unknown

(71) Applicant: Phong Nguyen, Brooklyn, NY (US)

(72) Inventor: Phong Nguyen, Brooklyn, NY (US)

(21) Appl. No.: 13/313,858

(22) Filed: Dec. 7, 2011

(51) Int. Cl. B62M 25/08

(52) U.S. Cl. 74/473.12

(57) ABSTRACT

A satellite electrical bicycle shift control device comprising: a mounting portion and a first electrical shift control switch portion attached to the mounting portion, the electrical shift control switch portion including an operating member moveable, relative to the mounting portion, between a neutral position and an actuating position.

### BACKGROUND OF THE INVENTION

1. Field of the Invention

This invention generally relates to an electrical bicycle shift control device.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle, especially the bicycle control devices for shifting and braking.

In the past, bicycle shifters were mechanically operated devices that were sometimes located near the brake levers of the bicycle. Thus, an operating force was typically applied by one of the rider's fingers to operate a shift control lever, which in turn transmitted the operating force to the drive component of a bicycle shifting mechanism by a cable that was fixed at one end to the control lever. More recently, electric switches have been used instead of mechanical control levers in order to operate the bicycle shifting mechanism. One example of an electrical shift control device is disclosed in U.S. Pat. No. 5,358,451. This patent discloses a plurality of electric switches may be provided at a plurality of handlebar locations in order to allow for quicker shifts and to enhance responsiveness. Another example of an electrical shift control device is disclosed in U.S. Patent Application Publication No. 2005/0211014. Other examples of electrical shift control devices are disclosed in U.S. Pat. No. 6,073,730 (discloses a pair of electric switches that may be provided in the side of the bracket body; U.S. Pat. No. 6,129,580; U.S. Pat. No. 5,676,021 and U.S. Pat. No. 6,546,827. Two such commercially available systems are “Dura-Ace® Di2 Road” and the “Dura-Ace® Di2 TT/Tri”, both by Shimano.

Recently, there has been a demand for so-called electronic satellite shifters. These are devices adapted to be fixated on special locations on the bicycle and to function as shifters in conjunction with the commercially available electrical shift control devices. Thus, sprinters might wish to have the electronic switches located in a different place on the handlebar than time-trialers, mountain bikers, recreational riders, road racers, etc. Each type of rider has different shifting patterns and requirements. Thus, there are presently available, satellite shifters configured to be fixated on the top of the handlebars and another type adapted to be located on the brake lever. The electronic gear shifting systems manufactured by Shimano allow for the use of these “satellite” shifters. Shimano currently offers two types of satellite shifters:

SW-7972: Shifting buttons are mounted on the lower portion of a drop handle bar. This allows for easy gear shifting while the rider is in an aggressive sprinting position.
SW-7970: Mounted on the top portion of a drop handlebar. This allows for easy gear shifting while the rider is in a more relaxed cruising position. The current Shimano offerings are functional. However, they are clunky in appearance and do not offer form, minimal weight, and maximum ergonomics.

Satellite shifters are equipped with male electric jacks or plugs adapted to fit the female electric sockets in the commercially available electrical shift control devices. At the present time, there are no satellite shifters which are configured to be fixated at any desired location on the bicycle. Thus, satellite shifters adapted to be fixated on top of the handlebar cannot be located elsewhere on the bicycle. Similarly, satellite shifters configured to be located on the brake levers cannot be installed elsewhere on the bicycle. Moreover, the commercially available satellite shifters are not maximally aerodynamic, thereby resulting in a sacrifice in performance.

In view of the above, it will be apparent to those skilled in the art from this disclosure that there exists a need for an improved satellite electronic shifter which can be installed at any location of the bicycle and which avoids the disadvantages associated with those commercially available. The invention addresses this need in the art as well as other needs, which will become apparent to those skilled in the art from this disclosure.

### SUMMARY OF THE INVENTION

One object of the present invention is to provide a maximally aerodynamic electronic satellite shifter that can be fixated at any location on the bicycle.

These and other objects, features, aspects and advantages of the present invention will become apparent to those skilled in the art from the following detailed descriptions, which, taken in conjunction with the annexed drawings, discloses a preferred embodiment of the present invention.

One embodiment of the invention relates to a satellite electrical bicycle shift control device comprising: a mounting portion that is configured to be fixedly or detachably mounted on a bicycle; and a first electrical shift control switch portion fixedly attached to the mounting portion, the electrical shift control switch portion including an operating member arranged and configured to be selectively moved relative to the mounting portion between a neutral position and an actuating position.

Another embodiment of the invention concerns the above described system further comprising a second electrical shift control switch portion fixedly attached to the mounting portion, the second electrical shift control switch portion also including an operating member arranged and configured to be selectively moved relative to the mounting portion between a neutral position and an actuating position; the second electrical shift control switch being spaced from the first electrical shift control switch.

### BRIEF DESCRIPTION OF THE DRAWINGS

Referring now to the attached drawings which form a part of this original disclosure:

FIG. 1 is a side elevational view of a typical bicycle equipped with an electronic derailleur control system.

FIG. 2 is a side elevational view of a prior art satellite shifter adapted to be installed on the top of a bicycle handlebar.

FIG. 3 is a top elevational view of an embodiment of the satellite shifter of the invention.

FIG. 4 is a side elevational view of an embodiment of the satellite shifter of the invention.

FIG. 5 is an exploded view of the satellite shifters illustrated in FIGS. 3 and 4.

FIG. 6 is a rear perspective view of an embodiment of the satellite shifter of the invention installed on the top of a mountain bike handlebar.

### DETAILED DESCRIPTION OF THE PREFERRED EMBODIMENTS

Selected embodiments of the present invention will now be explained with reference to the drawings where like reference numerals refer to like elements. It will be apparent to those skilled in the art from this disclosure that the following descriptions of the embodiments of the present invention are provided for illustration only and not for the purpose of limiting the invention as defined by the appended claims and their equivalents.

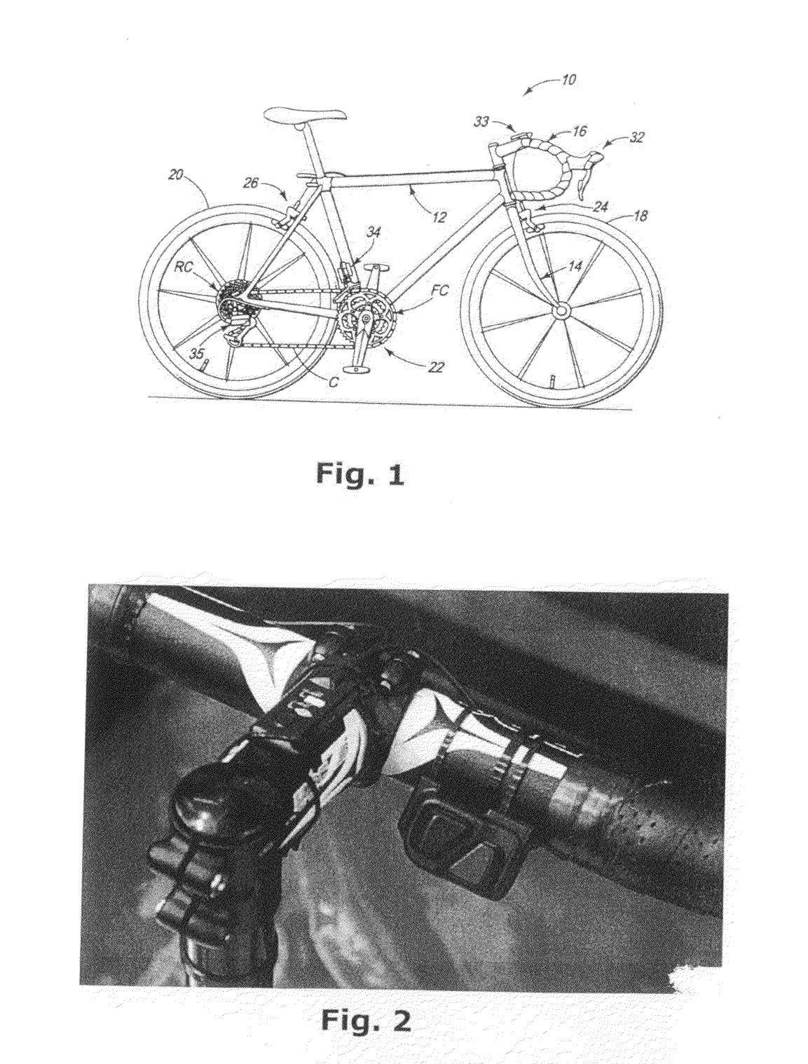

Referring initially to FIGS. 1 and 2, a bicycle 10 with an electronic derailleur control system is illustrated. The bicycle 10 is a road bicycle comprising a diamond-shaped frame 12, a front fork 14 rotatably mounted to the frame 12, a drop type bicycle handlebar 16 mounted to the upper part of the front fork 14, a front wheel 18 rotatably attached to the lower part of the front fork 14, a rear wheel 20 rotatably attached to the rear of frame 12, and a drive train or unit 22. A front wheel brake 24 is provided for applying a braking force to the front wheel 18, and a rear wheel brake 26 is provided for applying a braking force to the rear wheel 20. The electronic derailleur control system is configured and arranged so that it can be used with a variety of drive train configurations.

The bicycle is equipped with a cycle computer 33, a front electronic derailleur 34 and a rear electronic derailleur 35. The left and right hand side control devices 31 and 32 are essentially identical in construction and operation, except that they are mirror images. In the illustrated embodiment, the front dual control device 31 that is on the left hand side of the handlebar 16 is electrically connected to the front electronic derailleur 34, while the rear dual control device 32 that is on the right hand side of the handlebar 16 is electrically connected to the rear electronic derailleur 35. In any event, when the electronic derailleur control system is used to shift the drive train 22, the front electronic derailleur 34 selectively moves between two operating positions to switch the chain C between front sprockets using the front control device 31, while the rear electronic derailleur 35 selectively moves between, typically, ten operating positions to switch the chain C among selected ones of the rear sprockets using the rear control device 32.

As seen in FIG. 1, the drive train 22 basically comprises a chain C, a front crankset FC and a rear cassette RC. Since the parts of the drive train 22 are well known in the art, the parts of the drive train 22 will not be discussed or illustrated in detail herein, except for as they relate to the electronic derailleur control system of the present invention.

A commercially available electronic satellite shifter 17 fixated on the top of a handlebar 16 is illustrated in FIG. 2. As is apparent from the construction of the device, it offers a significantly large area to the air encountered when operating the bicycle, thereby increasing drag forces on the bicycle and reducing performance characteristics.

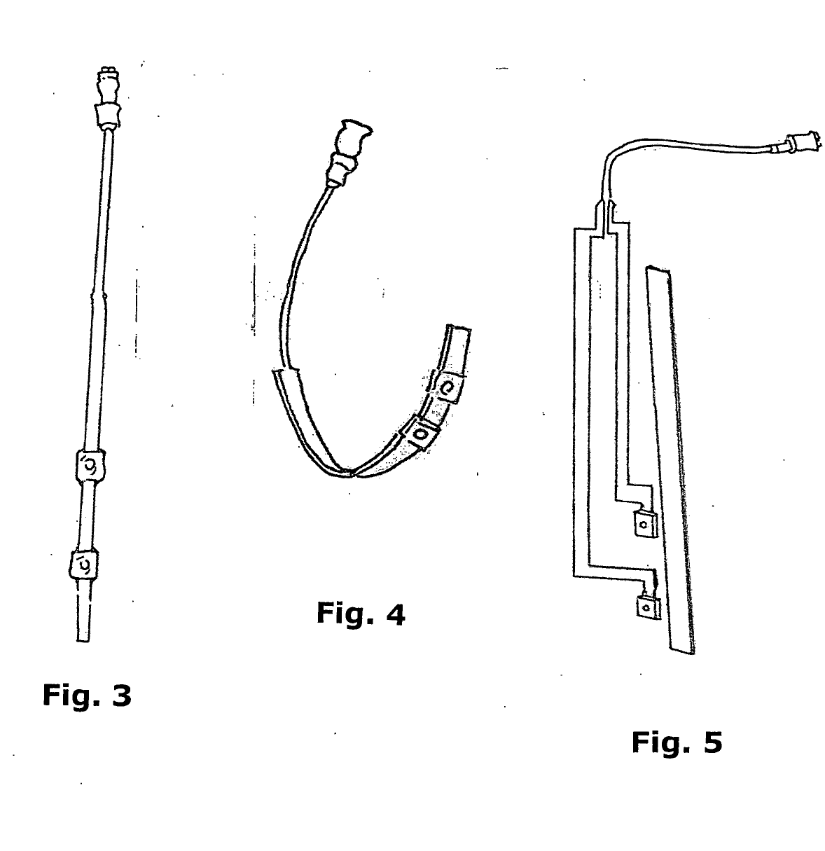

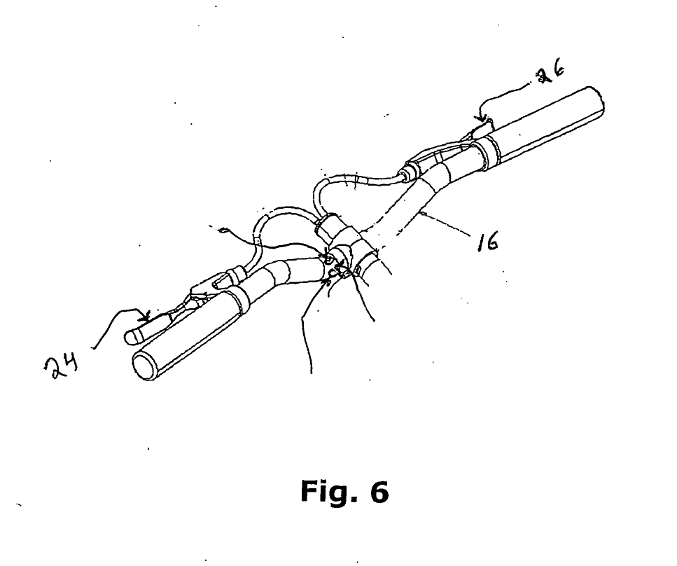

An embodiment of the satellite shifter of the invention is depicted in FIGS. 3-5. Two small electronic switches 48, powered by battery (not shown), and containing actuating buttons 46 are affixed to a flexible band 42. Each electronic switch 48 is electrically connected via electrical wires 52 to a jack that, in turn, connects to the electronic shifting system (not shown). The unit is encased in a form-fitting, flexible, plastic shrink-tube 44. The shifter may be wrapped around the handlebar and held in place with small amounts of epoxy or it may be mounted thereon so as to be removable; e.g., by a Velcro fastener system. It will be apparent to those skilled in the art that the satellite shifter of the invention is configured so as to be mountable anywhere on the bicycle; e.g., the handlebar, any portion of the frame or any component mounted thereon.

The electronic switch 48 and the actuating button 46 are preferably sealed against the elements by the encasing element 44 which is, preferably a shrink-wrapped plastic. The switch 48 is operated by pressing the area of the encasement 44 covering the button 46, which in turn presses against the button 46, thereby generating a switching signal to the electronic derailleur control system.

The band 42 and the encasing element 44 may be constructed of any suitable material that maintains the flexibility of the band 42 (metal, plastic, textile, and the like) and the element-proof nature of the coating 44 (plastic).

The electrical bicycle shift control device of the invention preferably has a maximum height in the Z axis direction, at its tallest point, is less than about 5 mm. The z-axis height is determined by the nature of the actuator switch and is maintained so as to reduce aerodynamic drag during operation of the bicycle to a minimum

What is claimed is:

1. A satellite electrical bicycle shift control device comprising: a mounting portion that is configured to be fixedly or detachably mounted on a bicycle; and a first electrical shift control switch portion fixedly attached to the mounting portion, the electrical shift control switch portion including an operating member arranged and configured to be selectively moved relative to the mounting portion between a neutral position and an actuating position.

2. The satellite electrical bicycle shift control device according to claim 1, further comprising a second electrical shift control switch portion fixedly attached to the mounting portion, the second electrical shift control switch portion also including an operating member arranged and configured to be selectively moved relative to the mounting portion between a neutral position and an actuating position; said second electrical shift control switch being spaced from the first electrical shift control switch.

3. The satellite electrical bicycle shift control device according to claim 2, wherein the electrical shift control switch portions further include a biasing element arranged and configured to urge the operating members to the neutral position.

4. The electrical bicycle shift control device according to claim 3, wherein the first electrical shift control switch increases a gear ratio when actuated and the second electrical shift control switch decreases a gear ratio when actuated.

5. The electrical bicycle shift control device according to claim 1, wherein the mounting portion is detachably coupled to the bicycle such that the mounting portion and attached electrical shift control switch portion can be removed from the bicycle.

6. The electrical bicycle shift control device according to claim 1, wherein the mounting portion comprises a thin flexible substrate configured to conform exactly to the surface of that portion of the bicycle to which it is configured to be fixedly or temporarily mounted.

7. The electrical bicycle shift control device according to claim 6 wherein the maximum height of the device in the Z axis direction, at its tallest point, is less than about 5 mm.

8. The electrical bicycle shift control device according to claim 6, wherein the thin flexible substrate is a metal band.

9. The electrical bicycle shift control device according to claim 6, wherein the mounting portion and attached electrical shift control switch portion are encased in an element proof material.

10. The electrical bicycle shift control device according to claim 9, wherein the encasement is form-fitting.

11. The electrical bicycle shift control device according to claim 10, wherein the encasement comprises a material shrink-wrapped around said mounting portion and attached electrical shift control switch portion.

12. The satellite electrical bicycle shift control device according to claim 9 wherein said encasement material is a polymeric material.

13. The satellite electrical bicycle shift control device according to claim 12 wherein said polymeric material comprises a natural polymer, or a synthetic thermoplastic or thermoset polymer.

14. The satellite electrical bicycle shift control device according to claim 1 configured to be fixedly mounted on a bicycle.

15. The satellite electrical bicycle shift control device according to claim 14 configured to be fixedly mounted on a bicycle handlebar.

16. The satellite electrical bicycle shift control device according to claim 1 configured to be detachably mounted on a bicycle.

17. The satellite electrical bicycle shift control device according to claim 14 configured to be detachably mounted on a bicycle handlebar.
